(19) United States
(12) Patent Application Publication
(10) Pub. No.: US 2025/0071214 A1
(43) Pub. Date: Feb. 27, 2025

(54) MEDIUM ACCOMMODATING DEVICE AND IMAGE FORMING SYSTEM

(71) Applicant: FUJIFILM Business Innovation Corp., Tokyo (JP)

(72) Inventor: Junki KAZAMA, Kanagawa (JP)

(73) Assignee: FUJIFILM Business Innovation Corp., Tokyo (JP)

(21) Appl. No.: 18/586,544

(22) Filed: Feb. 26, 2024

(30) Foreign Application Priority Data
Aug. 23, 2023 (JP) 2023-135691

(51) Int. Cl. H04N 1/00; G03G 15/00

(52) U.S. Cl. CPC H04N 1/00082; G03G 15/50; G03G 15/6511; H04N 1/00037; H04N 1/00092; H04N 1/00628

(57) ABSTRACT

A medium accommodating device includes: a loading unit on which media are loadable in an up-down direction; an air supply unit that supplies air to plural media loaded on the loading unit to float and separate the plural media; a sending unit that sequentially sends the media that are floated and separated by the air supply unit; a photographing unit that photographs a state in which the media are floated and separated by the air supply unit; an irradiation unit that irradiates side portions of the media with light; and an adjusting unit that adjusts an angle of the light irradiating the media from the irradiation unit.

### CROSS-REFERENCE TO RELATED APPLICATIONS

This application is based on and claims priority under 35 USC 119 from Japanese Patent Application No. 2023-135691 filed Aug. 23, 2023.

### BACKGROUND

### (i) Technical Field

The present disclosure relates to a medium accommodating device and an image forming system.

### (ii) Related Art

JP2020-152537A discloses a sheet feeding device including: an air blowing unit that blows air onto a sheet bundle loaded on a sheet loading unit to cause sheets on an upper portion of the sheet bundle to be floated; a feeding unit that feeds an uppermost sheet that is floated; a photographing unit that photographs the sheet floated by the air blowing unit; and a illumination unit that illuminates the floated sheet, in which a changing unit that changes a light irradiation range of the illumination unit in an up-down direction.

### SUMMARY

Aspects of non-limiting embodiments of the present disclosure relate to a medium accommodating device and an image forming system capable of, in a case where media are photographed in a state in which the media are floated and separated by blowing air, accurately detecting the media compared to a case where media are photographed by moving an irradiation unit up and down.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a medium accommodating device including: a loading unit on which media are loadable in an up-down direction; an air supply unit that supplies air to a plurality of the media loaded on the loading unit to float and separate the plurality of media; a sending unit that sequentially sends the media that are floated and separated by the air supply unit; a photographing unit that photographs a state in which the media are floated and separated by the air supply unit; an irradiation unit that irradiates side portions of the media with light; and an adjusting unit that adjusts an angle of the light irradiating the media from the irradiation unit.

### BRIEF DESCRIPTION OF THE DRAWINGS

Exemplary embodiment(s) of the present invention will be described in detail based on the following figures, wherein:

FIG. 1A is a front view showing a part of a medium accommodating device according to a first exemplary embodiment, and FIG. 1B is a schematic view showing an example of an image forming system including the medium accommodating device;

FIG. 2 is a plan view showing a part of the medium accommodating device according to the first exemplary embodiment;

FIG. 3 is a schematic cross-sectional view taken along a direction intersecting a sheet sending direction of the medium accommodating device according to the first exemplary embodiment, and is a view showing a first example of a state of an adjusting unit when end portions of sheets are photographed by a camera;

FIG. 4 is an enlarged configuration diagram showing a rotating device of the adjusting unit of the medium accommodating device according to the first exemplary embodiment;

FIG. 5 is a block diagram showing a hardware configuration of the medium accommodating device according to the first exemplary embodiment;

FIG. 6 is a schematic cross-sectional view taken along a direction intersecting the sheet sending direction of the medium accommodating device according to the first exemplary embodiment, and is a view showing a second example of the state of the adjusting unit when the end portions of the sheets are photographed by the camera;

FIG. 7A is a diagram showing a first example of a state in which floating and separation of the sheets are good, FIG. 7B is a diagram showing a second example of a state in which the floating and separation of the sheets are insufficient, and FIG. 7C is a diagram showing a third example of the state in which the floating and separation of the sheets are insufficient;

FIG. 8 is a flowchart showing a flow of a process of the medium accommodating device according to the first exemplary embodiment;

FIG. 9 is a schematic cross-sectional view taken along a direction intersecting a sheet sending direction of a medium accommodating device according to a second exemplary embodiment, and is a view showing a first example of a state of an adjusting unit when the end portions of the sheets are photographed by the camera;

FIG. 10 is a block diagram showing a hardware configuration of the medium accommodating device according to the second exemplary embodiment;

FIG. 11 is a schematic cross-sectional view taken along a direction intersecting the sheet sending direction of the medium accommodating device according to the second exemplary embodiment, and is a view showing a second example of the state of the adjusting unit when the end portions of the sheets are photographed by the camera; and

FIG. 12 is a view showing a photographed image obtained by photographing end portions of sheets in a medium accommodating device of a comparative example.

### DETAILED DESCRIPTION

Hereinafter, exemplary embodiments for carrying out the present invention will be described. In the following description, a direction indicated by arrow X in the drawings is defined as an apparatus width direction, and a direction indicated by arrow Y is defined as an apparatus height direction. In addition, a direction (arrow Z direction) orthogonal to each of the apparatus width direction and the apparatus height direction is defined as an apparatus depth direction.

### First Exemplary Embodiment

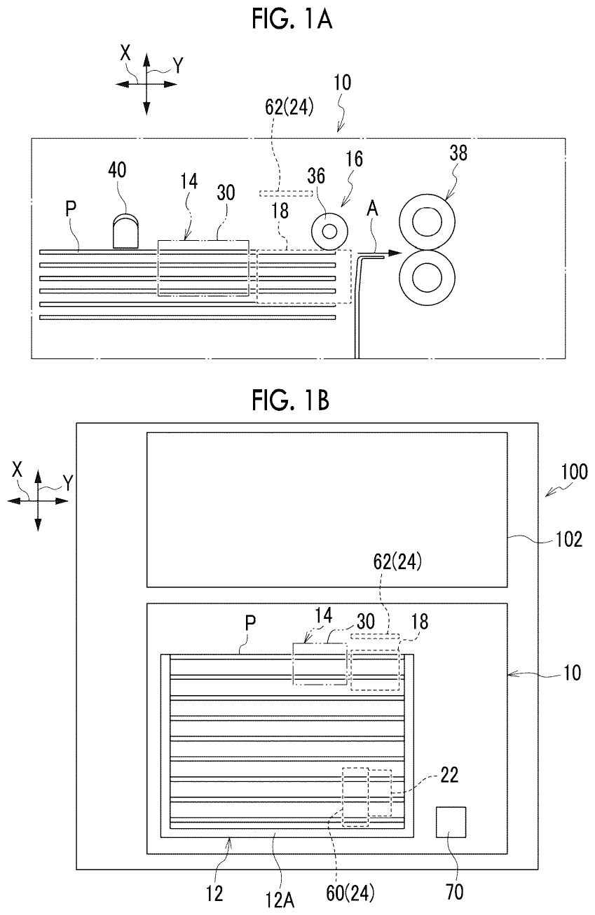

FIG. 1A shows a part of a medium accommodating device 10 according to a first exemplary embodiment, and FIG. 1B shows an example of an image forming system 100 including the medium accommodating device 10.

### Configuration of Image Forming System

As shown in FIG. 1B, the image forming system 100 includes an image forming unit 102 that forms an image on a sheet P as an example of a medium, and the medium accommodating device 10 that accommodates the sheet P to be supplied to the image forming unit 102. Although not shown, the image forming system 100 is provided with a transporting unit that transports sheets P accommodated in the medium accommodating device 10 one by one to be supplied to an image forming position in the image forming unit 102. A configuration and arrangement of the image forming unit 102 and a configuration and arrangement of the transporting unit are not particularly limited. In addition, the medium accommodating device 10 may be optionally configured to be attached to an image forming unit body of the image forming system.

### Configuration of Medium Accommodating Device

### Overall Configuration

As shown in FIGS. 1A and 1B, the medium accommodating device 10 includes a loading unit 12 on which the sheets P can be loaded in an up-down direction and an air supply unit 14 that supplies air to a plurality of sheets P loaded on the loading unit 12 to be floated and separated. In addition, the medium accommodating device 10 includes a sending unit 16 that sequentially sends the sheets P floated and separated by the air supply unit 14. In addition, the medium accommodating device 10 includes a camera 18 as an example of a photographing unit that photographs a state in which the sheets P are floated and separated by the air supply unit 14, and an irradiation unit 22 that irradiates side portions of the sheets P on a photographing side photographed by the camera 18 with light. In addition, the medium accommodating device 10 includes an adjusting unit 24 that adjusts an angle of light irradiating the sheets P from the irradiation unit 22. Furthermore, the medium accommodating device 10 includes a control device 50 that controls an operation of each unit. The control device 50 is an example of a processor.

### Loading Unit

As shown in FIG. 1B, the loading unit 12 includes a plate-shaped body 12A on which the plurality of sheets P can be loaded. Although not shown, the medium accommodating device 10 includes an elevating device that raises and lowers the plate-shaped body 12A in the up-down direction. The elevating device raises the plate-shaped body 12A so that a position of an uppermost sheet P of the sheets P loaded on an upper side of the plate-shaped body 12A reaches a predetermined height.

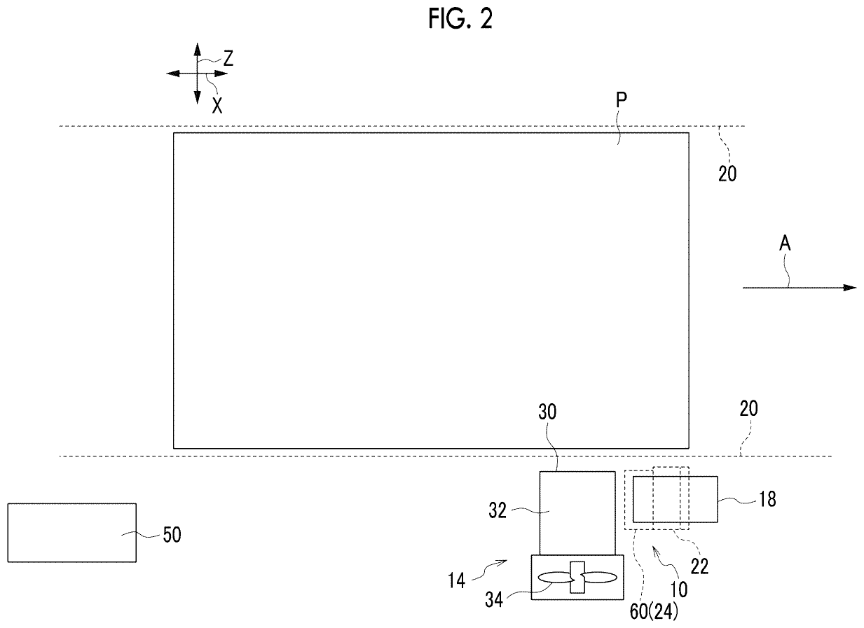

As shown in FIG. 2, the medium accommodating device 10 is provided with side guides 20 that restrict positions of side portions of the sheets P in a width direction (in this example, the arrow Z direction) loaded on the loading unit 12. The side guides 20 are arranged on an upper side of the loading unit 12 and are provided on both sides of the side portions of the sheets P in the width direction (arrow Z direction). As an example, the side guide 20 is slidably attached to the loading unit 12 in the apparatus depth direction (arrow Z direction). The side guide 20 can be slid in the apparatus depth direction (arrow Z direction) according to a size of the sheet P. A movement range of the side guide 20 is limited by a stopper (length of a guide slit) or the like (not shown) so as not to interfere with the sending unit 16.

### Air Supply Unit

As shown in FIGS. 1A and 2, the air supply unit 14 includes an air outlet 30 through which air is blown toward an upper side of the loading unit 12 in a direction from the side portion of the sheet P in the width direction (arrow Z direction). The air outlet 30 is arranged at a position facing an upper portion of the plurality of sheets P loaded on the upper side of the plate-shaped body 12A. The air supply unit 14 blows air from the air outlet 30 between the plurality of sheets P to float and separate the plurality of sheets P loaded on the plate-shaped body 12A of the loading unit 12.

The air supply unit 14 includes a duct 32 connected to the air outlet 30 and a fan 34 provided upstream of the duct 32 in an air flow direction (see FIG. 2). In the air supply unit 14, air is supplied to the air outlet 30 through the duct 32 by rotation of the fan 34, and air is blown out from the air outlet 30 to the upper side of the loading unit 12.

Although not shown, the air outlets 30 are provided on both sides of the side portions of the sheets P in the width direction (arrow Z direction). As an example, the air outlets 30 are provided at the side guides 20 on both sides of the side portions of the sheets P in the width direction (arrow Z direction). The duct 32 is branched into two portions on a side downstream of the fan 34 in the air flow direction, and the air outlet 30 is provided at each downstream end portion of the branched portion of the duct 32.

### Sending Unit

As shown in FIG. 1A, the sending unit 16 transports the sheets P loaded on the upper side of the plate-shaped body 12A of the loading unit 12 one by one in an arrow A direction, that is, toward a right side in the apparatus width direction (right side in an arrow X direction). The sending unit 16 includes a sending roll (feeding roll) 36 that sends the uppermost sheet P on the upper side of the loading unit 12 one by one. In addition, as an example, the sending unit 16 includes a sticking unit 40 arranged on an inner side (left side in the arrow X direction) in the apparatus width direction with respect to the sending roll 36, and the sticking unit 40 causes the uppermost sheet P to stick to the sticking unit 40. Furthermore, the sending unit 16 includes a pair of transporting rolls 38 that transport the sheet P sent by the sending roll 36.

As an example, in the sending unit 16, in a case where the sheet P caused to stick to the sticking unit 40 comes into contact with the sending roll 36, the sheet P is sent by the sending roll 36 in the arrow A direction, and is transported in the arrow A direction by the transporting rolls 38.

### Camera

The camera 18 photographs a floated and separated state of end portions of the sheets P. As shown in FIGS. 1A to 2, the camera 18 is provided on a side of the side portions of the sheets P in the width direction (arrow Z direction). The camera 18 is arranged at a position facing the end portions of the sheet P in the width direction (arrow Z direction) loaded on the plate-shaped body 12A. Accordingly, the camera 18 photographs the state in which the sheets Pare floated and separated from an outside of the end portions of the sheets in the width direction. As an example, the cameras 18 are provided on both sides of the end portions of the sheets Pin the width direction (arrow Z direction).

As an example, the camera 18 is arranged on an upper portion side of the side guide 20, and is arranged near the end portions on a downstream side in a sending direction (arrow A direction) of the sheets P in the side guide 20. As an example, the camera 18 is attached to the side guide 20 by an attachment tool (not shown).

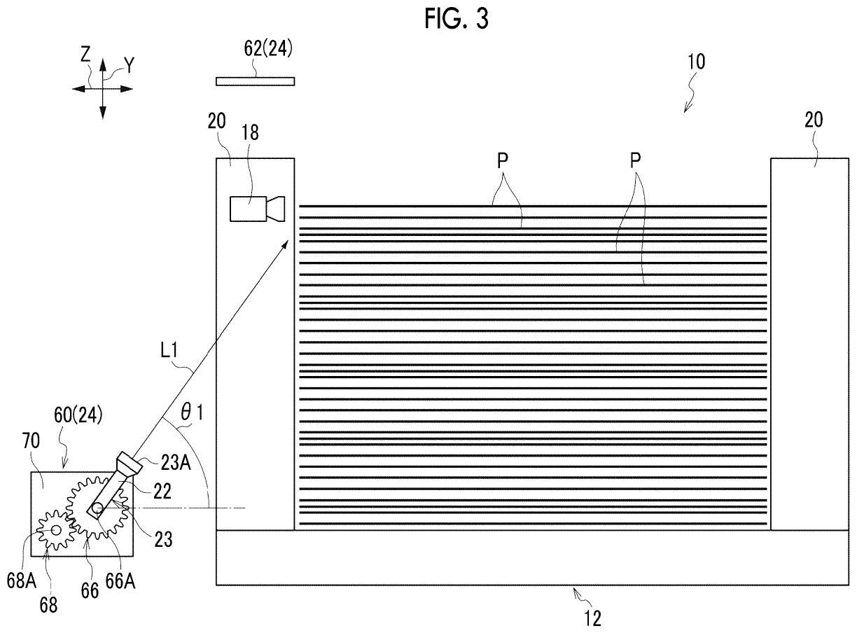

As shown in FIG. 3, the camera 18 is arranged at a position facing the plurality of sheets P that are floated and separated by the air from the air supply unit 14. As an example, the camera 18 is arranged on an upper side in the up-down direction facing the plurality of sheets P that are floated and separated by the air from the air supply unit 14. Here, the upper side in the up-down direction facing the plurality of sheets P refers to an upper portion side of a range in which the plurality of sheets P are scattered when a predetermined amount of air is blown.

### Irradiation Unit

The irradiation unit 22 has a function of irradiating the side portions of the sheets P on the photographing side with light when the sheets P are photographed by the camera 18. As shown in FIGS. 1B and 3, as an example, the irradiation unit 22 is arranged outside the side portions of the plurality of sheets P in the width direction (arrow Z direction) loaded on the loading unit 12 and on a lower side in the up-down direction of the medium accommodating device 10. As an example, the irradiation unit 22 is configured by a light source device that emits light from one light source (see FIG. 3). The irradiation unit 22 includes a case 23 having a length in a longitudinal direction thereof, and emits light L from an end surface 23A in the longitudinal direction of the case 23 (see FIG. 3).

In the first exemplary embodiment, the irradiation unit 22 is configured to irradiate the side portions of the sheets P in the width direction (arrow Z direction) with light by adjusting an angle of the light by the adjusting unit 24. FIG. 3 shows a first example in which the adjusting unit 24 adjusts the angle of the light from the irradiation unit 22 to irradiate the side portions of the sheets P on the photographing side with the light. In the first example shown in FIG. 3, the irradiation unit 22 directly irradiates the side portions of the sheets P in the width direction (arrow Z direction) on the upper side in the up-down direction (that is, on an upper side in a loading direction of the loading unit 12) with the light in a direction from the lower side in the up-down direction outside the width direction (arrow Z direction) of the plurality of sheets P loaded on the loading unit 12. This first example will be described later.

The irradiation unit 22 emits light having directivity. Directivity refers to a property in which an intensity of a wave differs depending on a direction from a light source. For example, laser light, which is a wave with aligned phases, travels straight and forms a beam with a small spread even when a distance from a light source increases. Therefore, the laser light is referred to as having “good directivity”. As an example, the irradiation unit 22 may be configured to emit laser light. In addition, as another example, the irradiation unit 22 may be provided with a slit (not shown) to prevent the light from spreading to the surroundings (that is, to allow the light to travel straight) such that light that has passed through the slit is emitted. Accordingly, light having directivity can be emitted.

### Adjusting Unit

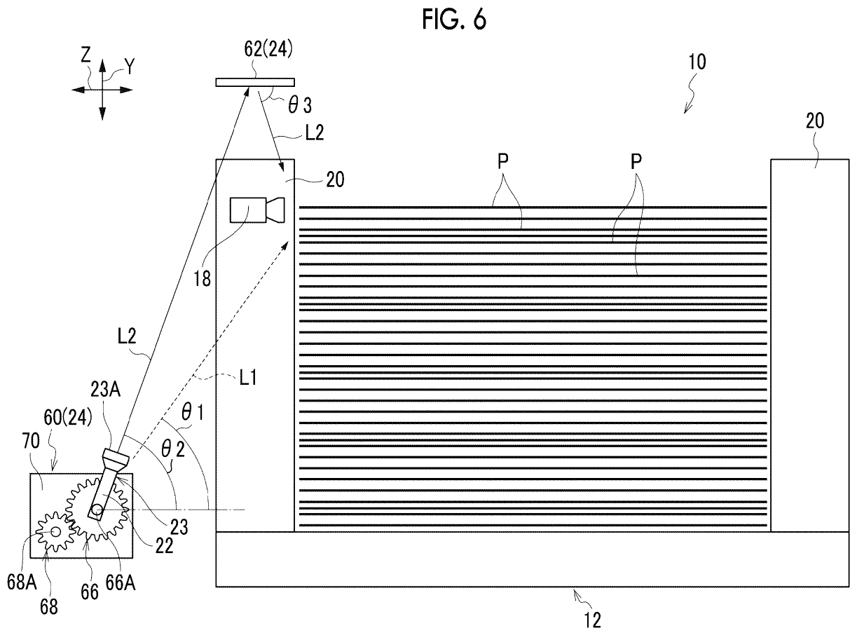

The adjusting unit 24 has a function of adjusting the angle of the light irradiating the side portions of the sheets P on the photographing side from the irradiation unit 22 as described above. As an example, the adjusting unit 24 adjusts an installation angle of the irradiation unit 22 with respect to the loading unit 12. As shown in FIGS. 3 and 6, the adjusting unit 24 includes a rotating device 60 that rotates the irradiation unit 22 in the up-down direction to change the installation angle of the irradiation unit 22 with respect to the loading unit 12, and a reflective material 62 that reflects the light emitted by the irradiation unit 22. The reflective material 62 is an example of a reflective portion.

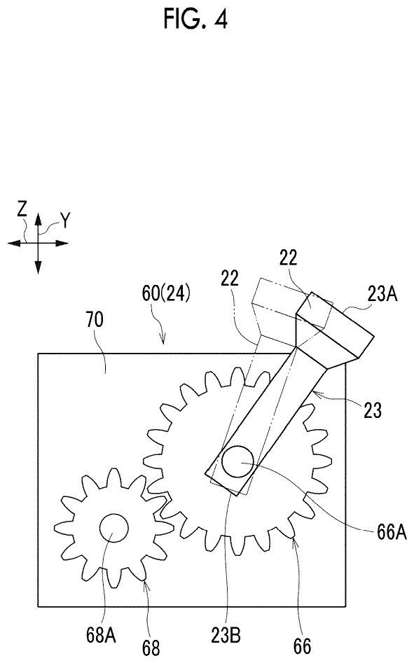

As shown in FIG. 4, as an example, the rotating device 60 includes a first gear 66 provided with a rotating shaft 66A that rotates the irradiation unit 22, a second gear 68 that meshes with the first gear 66, and a motor 70 that rotates a shaft portion 68A of the second gear 68. As an example, the rotating shaft 66A is provided at an end portion 23B on a side opposite to the end surface 23A from which the light is emitted in the case 23 of the irradiation unit 22.

In the rotating device 60, the motor 70 rotates the second gear 68 to rotate the first gear 66 that meshes with the second gear 68. As the rotating shaft 66A of the first gear 66 rotates, the irradiation unit 22 to which the rotating shaft 66A is attached rotates. An axial direction of the rotating shaft 66A is a direction along the apparatus width direction (arrow X direction), and by rotating the irradiation unit 22 around the rotating shaft 66A, the irradiation unit 22 is rotated in the up-down direction.

In the first example shown in FIG. 3, by the adjusting unit 24, the end surface 23A of the case 23 of the irradiation unit 22 is directed toward the side portions of the sheets in the width direction (arrow Z direction) P on the upper side in the up-down direction (that is, the upper side in the loading direction of the loading unit 12) from the lower side in the up-down direction outside the width direction (arrow Z direction) of the plurality of sheets P loaded on the loading unit 12. Here, the installation angle of the irradiation unit 22 with respect to the loading unit 12 can be represented by an angle θ1 in the axial direction of the irradiation unit 22 with respect to a horizontal direction.

Accordingly, the irradiation unit 22 irradiates the upper side in the up-down direction (that is, the upper side in the loading direction of the sheets P of the loading unit 12) with light L1 in an oblique direction from the lower side in the up-down direction, whereby the side portions of the sheets P in the width direction (arrow Z direction) are directly irradiated with the light L1. That is, the adjusting unit 24 adjusts the angle of the light to include a second angle (for example, the angle θ1 with respect to the horizontal direction) at which the side portions of the sheets P in the width direction (arrow Z direction) are irradiated with the light L1 from the lower side in the up-down direction of the sheets P floated and separated by the air supply unit 14.

FIG. 6 shows a second example in which the adjusting unit 24 adjusts the angle of the light from the irradiation unit 22 to irradiate the side portions of the sheets P on the photographing side with the light. In the second example shown in FIG. 6, the second gear 68 is rotated by the motor 70 of the rotating device 60 to rotate the first gear 66 that meshes with the second gear 68, so that the end surface 23A of the case 23 of the irradiation unit 22 is directed in a direction toward the reflective material 62. Here, the installation angle of the irradiation unit 22 with respect to the loading unit 12 can be represented by an angle θ2 in the axial direction of the irradiation unit 22 with respect to the horizontal direction. The installation angle of the irradiation unit 22 with respect to the loading unit 12 shown in FIG. 6 (that is, the angle θ2 in the axial direction of the irradiation unit 22 with respect to the horizontal direction) is larger than the installation angle of the irradiation unit 22 with respect to the loading unit 12 shown in FIG. 3 (that is, the angle θ1 in the axial direction of the irradiation unit 22 with respect to the horizontal direction).

As shown in FIG. 6, as an example, the reflective material 62 is arranged above the camera 18 in the up-down direction. The reflective material 62 is arranged outside in the width direction (arrow Z direction) of the plurality of sheets P loaded on the loading unit 12 and is arranged above the plurality of sheets P in the up-down direction. As an example, the reflective material 62 is a planar plate having a mirror surface, and is arranged along the horizontal direction.

In the second example shown in FIG. 6, the reflective material 62 reflects light L2 obliquely irradiating the upper side in the up-down direction from the irradiation unit 22 arranged on the lower side in the up-down direction of the medium accommodating device 10 (see FIG. 6). Since the light L2 is reflected obliquely downward in the up-down direction by the reflective material 62, the light L2 irradiates the side portions of the sheets P in the width direction (arrow Z direction). That is, in the first exemplary embodiment, the adjusting unit 24 adjusts the angle of the light to include a first angle (for example, an angle θ3 with respect to the horizontal direction) at which the side portions of the sheets P in the width direction (arrow Z direction) are irradiated with the light L2 from the upper side in the up-down direction of the sheets P floated and separated by the air supply unit 14.

### Hardware Configuration of Medium Accommodating Device

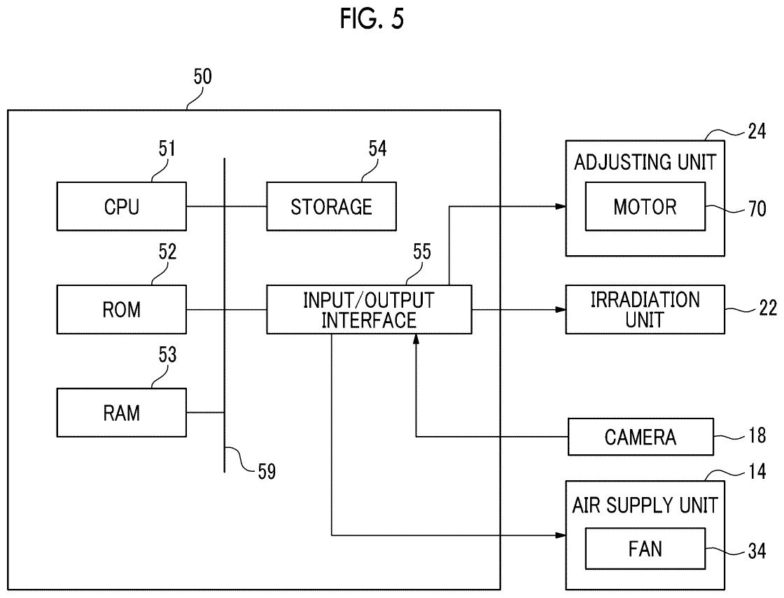

FIG. 5 is a block diagram showing a hardware configuration of devices mounted in the medium accommodating device 10. As shown in FIG. 5, the medium accommodating device 10 includes the control device 50, the camera 18, the air supply unit 14, the irradiation unit 22, and the adjusting unit 24 as described above.

The control device 50 has each configuration of a central processing unit (CPU) 51, a read only memory (ROM) 52, a random access memory (RAM) 53, a storage 54, and an input/output interface 55. The configurations are connected via a bus 59 to communicate with each other.

The CPU 51 is a central processing unit and executes various programs or controls each unit. The CPU 51 is an example of a processor. That is, the CPU 51 reads a program from the ROM 52 or the storage 54 and executes the program using the RAM 53 as a work area. The CPU 51 controls each configuration and performs various arithmetic processes according to the programs recorded on the ROM 52 or the storage 54. In the present exemplary embodiment, a detection process program is stored in the ROM 52 or the storage 54.

The ROM 52 stores various programs and various data. The RAM 53 temporarily stores programs or data as a work area. The storage 54 is configured by a hard disk drive (HDD) or a solid state drive (SSD), and stores various programs including an operating system and various data. A program of a printer driver is stored in the storage 54. The CPU 51 reads the program of the printer driver from the storage 54 and executes the program to function as the printer driver.

The input/output interface 55 is an interface for communicating with each device mounted in the medium accommodating device 10. The control device 50 is connected to the camera 18, the air supply unit 14, the irradiation unit 22, and the adjusting unit 24 via the input/output interface 55. The camera 18, the air supply unit 14, the irradiation unit 22, and the adjusting unit 24 may be directly connected to the control device 50 via the bus 59.

The CPU 51 controls turning on and off of the irradiation unit 22.

The CPU 51 rotates the irradiation unit 22 by controlling the motor 70 of the adjusting unit 24 to change the angle in the axial direction of the irradiation unit 22 with respect to the loading unit 12. The CPU 51 acquires a plurality of photographed images by photographing the side portions of the sheets P in the width direction (arrow Z direction) with the camera 18 in a state where the angle in the axial direction of the irradiation unit 22 is changed. In the first exemplary embodiment, the CPU 51 causes the adjusting unit 24 to adjust the angle of the light to include the second angle (for example, the angle θ1 with respect to the horizontal direction) at which the side portions of the sheets P in the width direction (arrow Z direction) are irradiated with the light L1 from the lower side in the up-down direction of the sheets P, and the first angle (for example, the angle θ3 with respect to the horizontal direction) at which the side portions of the sheets P in the width direction (arrow Z direction) are irradiated with the light L2 from the upper side in the up-down direction of the sheets P. In this state, the side portions of the sheets P in the width direction (arrow Z direction) are photographed by the camera 18. The CPU 51 acquires the plurality of photographed images by changing the angle of the light as described above. For example, the plurality of photographed images preferably include photographed images in at least the state shown in FIG. 3 and the state shown in FIG. 6, but may also include one or two or more photographed images while the irradiation unit 22 is rotated between the state shown in FIG. 3 and the state shown in FIG. 6.

The CPU 51 calculates the positions of the side portions of the sheets P in the width direction based on the plurality of photographed images of the side portions of the sheets P in the width direction (arrow Z direction) photographed by the camera 18. The CPU 51 determines whether or not there is a possibility of a jam or double feed of the sheets P from the floated and separated state of the side portions of the sheets P in the width direction detected by the calculation.

The CPU 51 changes the amount of air supplied by the air supply unit 14 in a case where it is determined that there is a possibility of a jam or double feed of the sheets P.

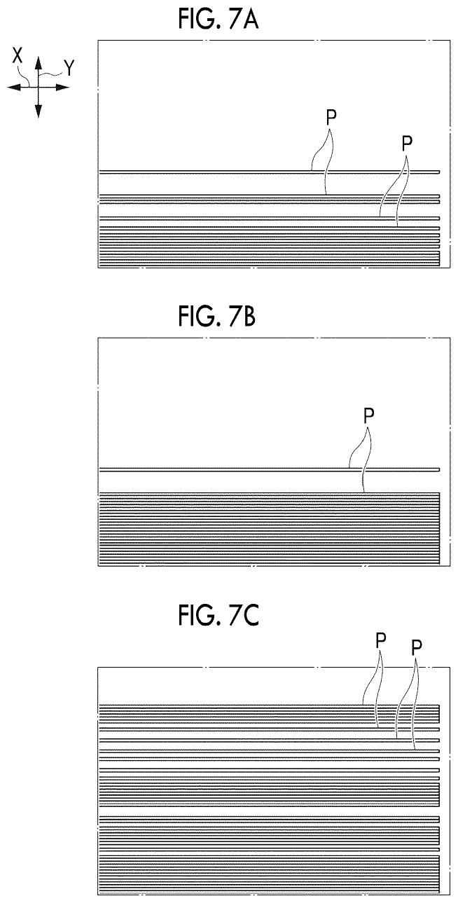

FIGS. 7A to 7C show examples of a state of the sheets P when air is blown from the air outlet 30 of the air supply unit 14 toward the sheets P loaded on the plate-shaped body 12A of the loading unit 12. In a first example shown in the FIG. 7A, about 10 sheets P on an upper portion side are independently separated and floated, so that the floated and separated state of the sheets P is good. In this state, even in a case where the sheets P are sequentially transported by the sending unit 16, a double feed of the sheets P or the like is less likely to occur. In such a case, the CPU 51 determines that there is no possibility of a jam or double feed of the sheets P.

In a second example shown in FIG. 7B, the number of sheets P floated is only about one, and the floated and separated state of the sheets P is insufficient. In this state, in a case where the sheets P are sequentially transported by the sending unit 16, there is a possibility of a supply failure (that is, misfeed) in which the sheets P are not smoothly supplied. In such a case, the CPU 51 determines that there is a possibility of a jam or double feed of the sheets P.

In a third example shown in FIG. 7C, since air is blown too strongly from the air outlet 30, the sheets P on the upper portion side are in a bundle and are floated, so that the floated and separated state of the sheets P is insufficient. In this state, in a case where the sheets P are sequentially transported by the sending unit 16, there is a possibility of a double feed of the sheets P. In such a case, the CPU 51 determines that there is a possibility of a jam or double feed of the sheets P.

For example, as shown in FIG. 7B, in a case where the floated and separated state of the sheets P is insufficient (the number of sheets P floated and separated is small), the CPU 51 increases the amount of air supplied by the air supply unit 14. In addition, for example, as shown in FIG. 7C, in a case where the number of sheets P floated is too large and a plurality of sheets P are in a bundle and are not sufficiently separated, the CPU 51 reduces the amount of air supplied by the air supply unit 14. For example, changing the amount of air supplied by the air supply unit 14 is executed by changing a rotation speed of the fan 34.

### Configuration and Problems of Medium Accommodating Device of Comparative Example

Here, a configuration and problems of a medium accommodating device of a comparative example will be described.

Although not shown, the medium accommodating device of the comparative example includes one illumination unit of which a position in an up-down direction is fixed, and a camera. Then, an end portion of a sheet P in a width direction is photographed by the camera in a state of being irradiated with light by the one illumination unit. The medium accommodating device of the comparative example is not provided with an adjusting unit that adjusts an installation angle of the illumination unit with respect to a loading unit.

In general, in a configuration in which a plurality of sheets P are floated and separated by air blown from an air supply unit, the sheets P can easily move in units of several mm in a depth direction facing the camera. Therefore, in the medium accommodating device of the comparative example, when end portions of the plurality of sheets P in the width direction are photographed by the camera in a state of being irradiated with light by the one illumination unit, there may be cases where brightness of the end portions of the plurality of sheets P in the up-down direction changes.

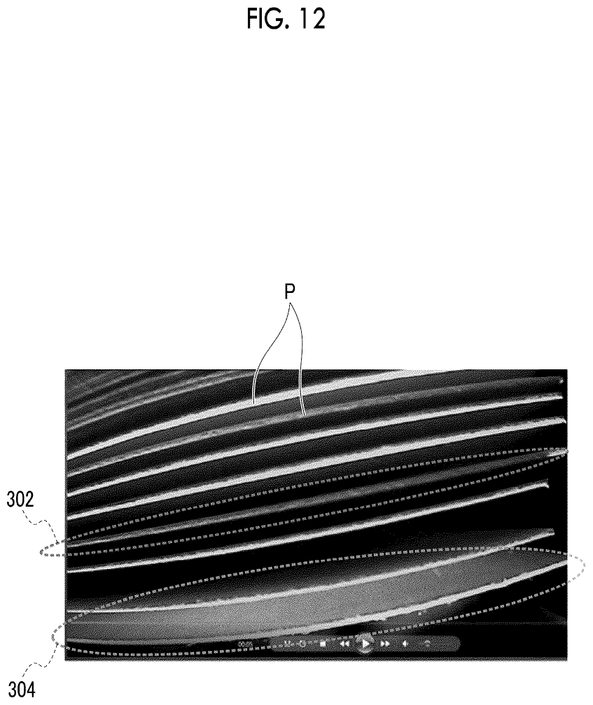

FIG. 12 is a photographed image obtained by photographing the end portions of the sheets P in the width direction with the camera in the medium accommodating device of the comparative example. As shown in FIG. 12, in a first area 302 in the photographed image, the sheet P moved toward a back side in the depth direction with respect to the camera is darker than the other sheets P. This is because the sheet P moved toward the back side in the depth direction with respect to the camera is hidden by another sheet P directly above or directly below the sheet P, and is less likely to be hit by the light of the illumination unit, so that the sheet P looks darker than the other sheets P. Therefore, when a floated and separated state of the plurality of sheets P is photographed, there may be cases where the sheets P in the first area 302 cannot be detected.

In addition, as shown in FIG. 12, in a second area 304 in the photographed image, since the illumination unit irradiates the sheets P with light from a front side of the sheets P, upper surfaces of the sheets P shine. For example, in a case where the light of the illumination unit hits a sheet P from a side of the sheet at a slight angle with respect to the sheet P, instead of from directly beside the sheet P, the light hits a surface of the sheet P. Therefore, when the sheet P is photographed by the camera, there may be cases where an upper surface or a lower surface of the sheet P shines and is reflected, and the sheet P is erroneously detected as a thick sheet P.

### ACTIONS AND EFFECTS

Next, actions of the first exemplary embodiment will be described.

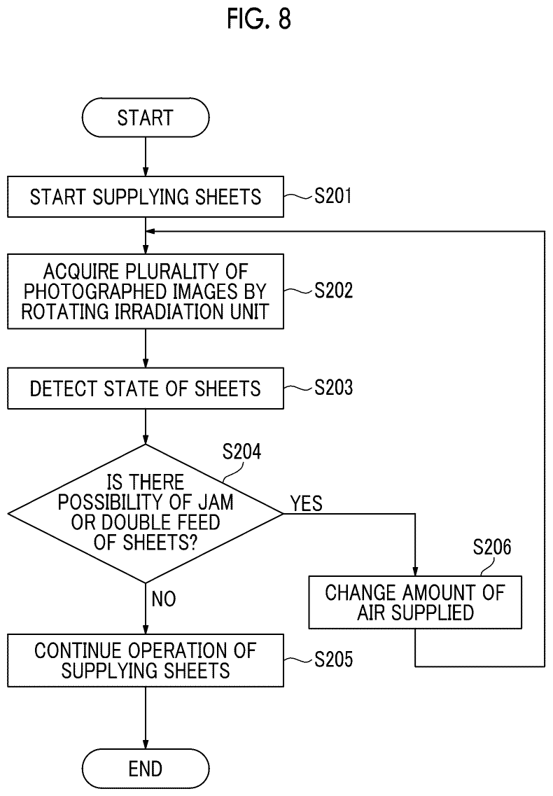

FIG. 8 is a flowchart showing a flow of a detection process in charge of the control device 50. The detection process is performed by the CPU 51 reading the detection process program from the ROM 52 or the storage 54, deploying the detection process program into the RAM 53, and executing the detection process program.

Before the detection process shown in FIG. 8 is executed, a user instructs the image forming system 100 to print image data on the sheets P. In a case where the image forming system 100 receives the printing instruction, the medium accommodating device 10 supplies air through the air supply unit 14 to float and separate the sheets P loaded on the loading unit 12.

The CPU 51 starts supplying the sheets P (step S201).

The CPU 51 causes the irradiation unit 22 to rotate to acquire a plurality of photographed images (step S202). Specifically, in a state where the irradiation unit 22 is rotated by the rotating device 60 to change the angle of the light emitted from the irradiation unit 22, the side portions of the sheets P in the width direction (arrow Z direction) are photographed by the camera 18 to acquire the plurality of photographed images. As shown in FIGS. 3 and 6, the CPU 51 controls the adjusting unit 24 to adjust the angle of the light to include the second angle (for example, the angle θ1 with respect to the horizontal direction) at which the side portions of the sheets P in the width direction (arrow Z direction) are irradiated with the light L1 from the lower side in the up-down direction of the sheets P, and the first angle (for example, the angle θ3 with respect to the horizontal direction) at which the side portions of the sheets P in the width direction (arrow Z direction) are irradiated with the light L2 from the upper side in the up-down direction of the sheets P. In this state, the side portions of the sheets P in the width direction (arrow Z direction) are photographed by the camera 18.

The CPU 51 detects a state of the sheets P, that is, the floated and separated state of the end portions of the sheets P in the width direction (arrow Z direction) from the plurality of photographed images (step S203). For example, the CPU 51 may exclude a non-discriminable area in the plurality of photographed images and detect the end portions of the sheets P in the width direction (arrow Z direction) in only a discriminable area.

The CPU 51 determines whether or not there is a possibility of a jam or double feed of the sheets P (step S204). For example, the CPU 51 determines whether or not there is a possibility of a jam or double feed of the sheets P based on the floated and separated state of the end portions of the sheets P in the width direction (arrow Z direction) as shown in FIGS. 7A to 7C.

In a case where there is no possibility of a jam or double feed of the sheets P (NO in step S204), the CPU 51 continues an operation of supplying the sheets P (step S205). That is, the amount of air supplied by the air supply unit 14 is not changed.

In a case where there is a possibility of a jam or double feed of the sheets P (YES in step S204), the CPU 51 changes the amount of air supplied by the air supply unit 14 (step S206). Accordingly, the floated and separated state of the sheets P loaded on the loading unit 12 are adjusted. Furthermore, the CPU 51 returns to the process of step S202. Accordingly, the process based on the detection process program in charge of the control device 50 is ended.

In addition, after step S206, in a case where a predetermined time has elapsed, the CPU 51 may display an alert indicating that there is a possibility of a jam or double feed of the sheets P, and stop supplying of the sheets P.

In the medium accommodating device 10 described above, the adjusting unit 24 adjusts the angle of the light irradiating the sheets P from the irradiation unit 22, and the camera 18 photographs the floated and separated state of the sheets P. Accordingly, the plurality of photographed images obtained by photographing the sheets P with the camera 18 are acquired in a state where the angle of the light irradiating the sheets P from the irradiation unit 22 is changed by the adjusting unit 24. Here, in order to adjust the angle of the light irradiating the sheets P from the irradiation unit 22 by the adjusting unit 24, for example, compared to a case where the irradiation unit is moved up and down without changing the angle of the light from the illumination unit, the angle of the light irradiating the sheets P can be appropriately adjusted. Therefore, in the medium accommodating device 10, in a case where the media are photographed in a state in which air is blown to float and separate the sheets P, compared to a case where the irradiation unit is moved up and down to photograph the sheets P, the sheets P may be detected accurately.

In addition, in the medium accommodating device 10, the camera 18 photographs the side portions of the sheets P in the width direction from the outside in the width direction intersecting the sending direction of the sheets P, and the irradiation unit 22 irradiates the side portions of the sheets P in the width direction with the light by adjusting the angle of the light by the adjusting unit 24. Therefore, in the medium accommodating device 10, compared to a case where the camera photographs the side portions of the sheets P in a direction along the sending direction of the sheets P and the irradiation unit irradiates the side portions of the sheets P in the direction along the sending direction of the sheets P with the light, the arrangement of each member is easy.

In addition, in the medium accommodating device 10, the adjusting unit 24 includes the reflective material 62 that reflects the light emitted from the irradiation unit 22. Therefore, in the medium accommodating device 10, compared to a case where the sheets P are only directly irradiated with the light emitted from the irradiation unit, the sheets P may be detected accurately.

In addition, in the medium accommodating device 10, the adjusting unit 24 adjusts the installation angle of the irradiation unit 22 with respect to the loading unit 12. Therefore, in the medium accommodating device 10, compared to a case where the installation angle of the irradiation unit with respect to the loading unit is fixed, the sheets P may be detected accurately.

In addition, in the medium accommodating device 10, the adjusting unit 24 rotates the irradiation unit 22 in the up-down direction by rotating the irradiation unit 22 around the rotating shaft 66A. Therefore, in the medium accommodating device 10, compared to a case where the irradiation unit is moved in the up-down direction, the irradiation unit 22 may be rotated around the rotating shaft 66A within a short period of time.

In addition, in the medium accommodating device 10, the adjusting unit 24 adjusts the angle of the light to include the second angle (for example, the angle θ1 with respect to the horizontal direction) at which the side portions of the sheets P in the width direction (arrow Z direction) are irradiated with the light L1 from the lower side in the up-down direction of the sheets P, and the first angle (for example, the angle θ3 with respect to the horizontal direction) at which the side portions of the sheets P in the width direction (arrow Z direction) are irradiated with the light L2 from the upper side in the up-down direction of the sheets P. Therefore, in the medium accommodating device 10, compared to a case where the angle of the light is adjusted to emit light from only the upper side in the up-down direction or only the lower side in the up-down direction of the sheets P floated and separated by the air supply unit, the sheets P may be detected accurately.

In addition, in the medium accommodating device 10, the irradiation unit 22 emits light having directivity. Therefore, in the medium accommodating device 10, compared to a case where dispersed light is emitted, the media may be detected accurately.

In addition, in the medium accommodating device 10, the CPU 51 changes the amount of air supplied by the air supply unit 14 based on the image photographed by the camera 18. Therefore, in the medium accommodating device 10, compared to a case where the amount of air supplied is not changed, a jam or double feed of the sheets P may be suppressed.

Furthermore, the image forming system 100 includes the medium accommodating device 10 and the image forming unit 102 that forms an image on the sheet P sent from the medium accommodating device 10 by the sending unit 16. Therefore, according to the image forming system 100, in a case where the sheets P are photographed in a state in which the sheets P are floated and separated by the blown air, compared to a case where the irradiation unit is moved up and down to photograph the media, the sheets P may be detected accurately.

### Second Exemplary Embodiment

Next, a medium accommodating device of a second exemplary embodiment will be described. It should be noted that the identical reference numerals are assigned to the identical configuration parts to the first exemplary embodiment described above, and the description thereof will be omitted as appropriate.

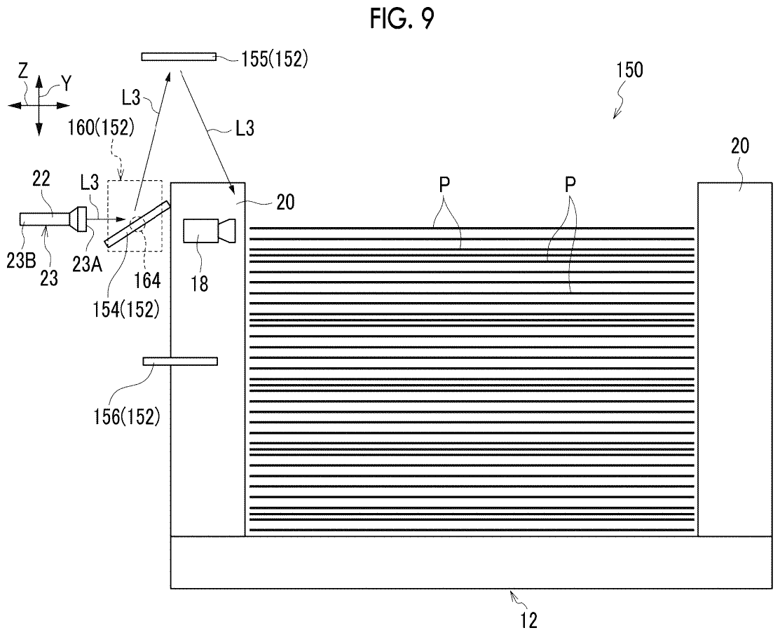

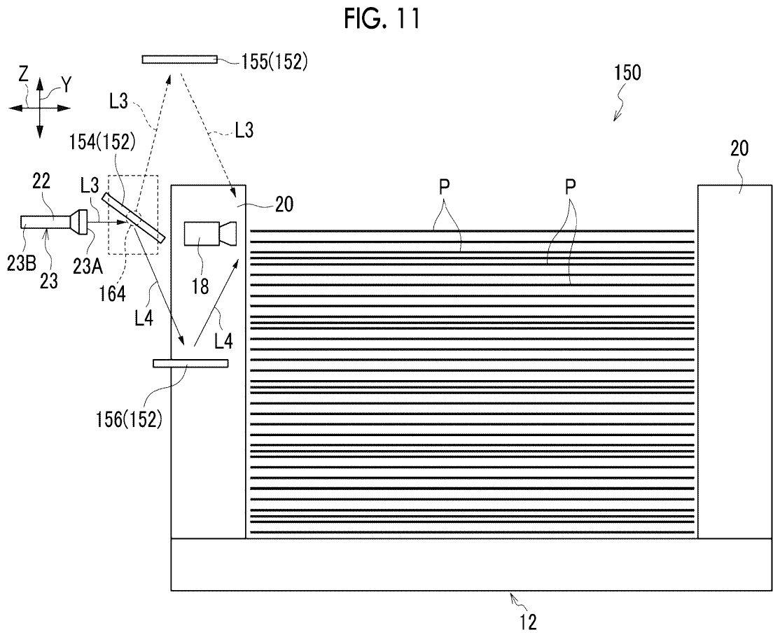

As shown in FIGS. 9 to 11, a medium accommodating device 150 of the second exemplary embodiment is different in an attachment structure of the irradiation unit 22 and a configuration of an adjusting unit 152 from the medium accommodating device 10 of the first exemplary embodiment. As shown in FIGS. 9 and 11, in the medium accommodating device 150, the irradiation unit 22 is provided outside an upper portion of the side guide 20 in the up-down direction. Although not shown, the irradiation unit 22 is fixed to a frame such as the side guide 20 by an attachment tool. That is, the irradiation unit 22 does not rotate relative to the loading unit 12. The irradiation unit 22 is arranged such that a longitudinal direction thereof is along a surface direction (that is, the horizontal direction) of the sheets P, and emits light laterally from the end surface 23A of the case 23.

As shown in FIG. 9, the adjusting unit 152 includes a plurality of (for example, three) reflective materials 154, 155, and 156. The reflective materials 154, 155, and 156 are examples of a plurality of reflective portions. As shown in FIGS. 9 and 11, the adjusting unit 152 adjusts the angle of the light irradiating the sheets P by selection of the plurality of reflective materials 154, 155, and 156.

The reflective material 154 is arranged obliquely at a position facing the end surface 23A of the case 23 in the irradiation unit 22 to intersect the horizontal direction. The adjusting unit 152 adjusts an installation angle of the reflective material 154 on which the light from the irradiation unit 22 is first reflected with respect to the loading unit 12.

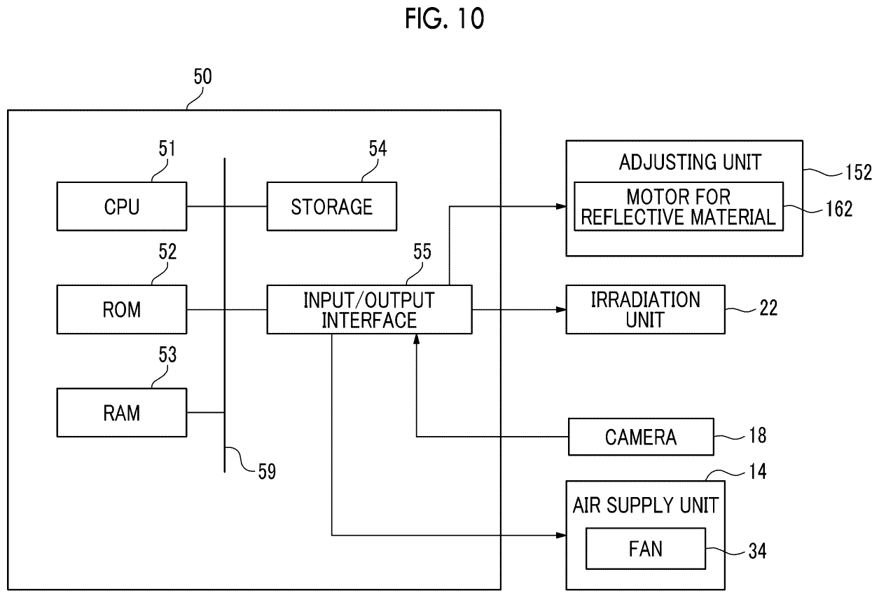

As an example, the adjusting unit 152 includes a rotating device 160 that rotates the reflective material 154 around a rotating shaft 164. A configuration of the rotating device 160 is the same as a configuration of the rotating device 60 of the first exemplary embodiment. Specifically, the rotating device 160 includes the rotating shaft 164 provided at an intermediate portion of the reflective material 154 in a surface direction thereof, and a motor 162 for the reflective material 154 that rotates the rotating shaft 164 (see FIG. 10). An axial direction of the rotating shaft 164 is arranged along the apparatus width direction (arrow X direction), and the reflective material 154 is rotated in the up-down direction by the rotating shaft 164. As an example, the reflective material 154 is a planar plate having a mirror surface.

In addition, the reflective material 155 is arranged above the camera 18 provided in the side guide 20 in the up-down direction (that is, above the reflective material 154 in the up-down direction), and is arranged at a position shifted from the reflective material 154 in the apparatus depth direction (arrow Z direction). The reflective material 155 is arranged on a side of the sheets P loaded on the loading unit 12 with respect to the reflective material 154 in the apparatus depth direction (arrow Z direction). As an example, the reflective material 155 is a planar plate having a mirror surface, and is arranged along the horizontal direction.

For example, in FIG. 9, the reflective material 154 is inclined such that a side of the irradiation unit 22 is on the lower side and a side of the side guide 20 is on the upper side. Accordingly, light L3 emitted from the end surface 23A of the irradiation unit 22 is reflected upward by the reflective material 154. The reflective material 155 is arranged at a position that the light L3 reflected by the reflective material 154 reaches. Furthermore, the light reflected by the reflective material 155 irradiates the side portions of the sheets P in the width direction (arrow Z direction).

In addition, the reflective material 156 is arranged below the camera 18 provided in the side guide 20 in the up-down direction (that is, below the reflective material 154 in the up-down direction), and is arranged at a position shifted from the reflective material 154 in the apparatus depth direction (arrow Z direction). The reflective material 156 is disposed on the side of the sheet P loaded on the loading unit 12 with respect to the reflective material 154 in the apparatus depth direction (direction of arrow Z). As an example, the reflective material 156 is a planar plate having a mirror surface, and is arranged along the horizontal direction.

FIG. 10 is a block diagram showing a hardware configuration of devices mounted in the medium accommodating device 150. As shown in FIG. 10, the medium accommodating device 150 is different from the medium accommodating device 10 of the first exemplary embodiment in that the CPU 51 controls the motor 162 for the reflective material of the adjusting unit 152.

For example, in FIG. 11, by rotating the reflective material 154 around the rotating shaft 164 by the rotating device 160, the reflective material 154 is inclined such that the side of the irradiation unit 22 is on the upper side and the side of the side guide 20 is on the lower side. Accordingly, light L4 emitted from the end surface 23A of the irradiation unit 22 is reflected downward by the reflective material 154. The reflective material 156 is arranged at a position that the light L4 reflected by the reflective material 154 reaches. Furthermore, the light L4 reflected by the reflective material 156 irradiates the side portions of the sheets P in the width direction (the arrow Z direction). Other configurations of the medium accommodating device 150 are the same as configurations of the medium accommodating device 10 of the first exemplary embodiment.

The medium accommodating device 150 has the following actions and effects in addition to the actions and effects of the same configuration as the medium accommodating device 10 of the first exemplary embodiment.

In the medium accommodating device 150, the plurality of (for example, three) reflective materials 154, 155, and 156 are provided. For example, as shown in FIGS. 9 and 11, the adjusting unit 152 adjusts the angle of the light irradiating the sheets P by selection of the plurality of reflective materials 154, 155, and 156. Therefore, in the medium accommodating device 150, the sheets P may be detected accurately compared to a case where there is one reflective material.

In addition, in the medium accommodating device 150, the adjusting unit 152 adjusts the installation angle of the reflective material 154 on which the light from the irradiation unit 22 is first reflected with respect to the loading unit 12. Therefore, in the medium accommodating device 150, the sheets P may be detected accurately compared to a case where the installation angle of the reflective material with respect to the loading unit is fixed.

In addition, in the medium accommodating device 150, the adjusting unit 152 rotates the reflective material 154 around the rotating shaft 164 to rotate the reflective material 154 in the up-down direction. Therefore, in the medium accommodating device 150, the reflective material 154 may be rotated around the rotating shaft 164 within a short period of time compared to a case where the reflective material is moved in the up-down direction.

### Supplementary Description

In the medium accommodating device 10 of the first exemplary embodiment, the reflective material 62 is provided, but the present disclosure is not limited to this configuration. For example, a configuration including the adjusting unit 24 provided with the rotating device 60 without the reflective material 62 may be provided.

In the medium accommodating device 10 of the first exemplary embodiment, the irradiation unit 22 is rotated, and in the medium accommodating device 150 of the second exemplary embodiment, the reflective material 154 is rotated. However, the present disclosure is not limited to this configuration. For example, a configuration in which both the irradiation unit and the reflective material are rotated may be provided. Alternatively, the reflective material to be rotated may be changed to another reflective material.

In the medium accommodating device 150 of the second exemplary embodiment, the reflective materials 155 and 156 are arranged along the horizontal direction, but the present disclosure is not limited to this configuration. For example, a configuration in which the reflective materials 155 and 156 are inclined in a direction intersecting the horizontal direction may be provided. In addition, the plurality of reflective materials 154, 155, and 156 are planar plates, but the present disclosure is not limited to this configuration. For example, at least one of the plurality of reflective materials may have a shape in which a side on which the light is incident is concavely curved. In addition, the number of the plurality of reflective materials and the positions of the plurality of reflective materials are changeable.

The process of the medium accommodating devices 10 and 150 described above can also be realized by a dedicated hardware circuit. In this case, the process may be executed by one hardware or may be executed by a plurality of pieces of hardware.

In addition, the program for operating the medium accommodating devices 10 and 150 may be provided by a computer-readable recording medium such as a Universal Serial Bus (USB) memory, a flexible disk, or a Compact Disc Read Only Memory (CD-ROM), or may be provided online via a network such as the Internet. In this case, the program recorded on the computer-readable recording medium is usually transferred to a memory, a storage, or the like and stored. In addition, for example, this program may be provided as a single application software, or may be incorporated into software of each device as a function of the medium accommodating devices 10 and 150 or the image forming system 100.

It should be noted that, although the present invention has been described in detail with respect to specific exemplary embodiments, the present invention is not limited to such exemplary embodiments, and it will be apparent to a person skilled in the art that various other exemplary embodiments are possible within the scope of the present invention.

### ASPECTS OF PRESENT DISCLOSURE

Hereinafter, aspects of the present disclosure will be additionally described.

(((1)))

A medium accommodating device comprising:
a loading unit on which media are loadable in an up-down direction;
an air supply unit that supplies air to a plurality of the media loaded on the loading unit to float and separate the plurality of media;
a sending unit that sequentially sends the media that are floated and separated by the air supply unit;
a photographing unit that photographs a state in which the media are floated and separated by the air supply unit;
an irradiation unit that irradiates side portions of the media with light; and
an adjusting unit that adjusts an angle of the light irradiating the media from the irradiation unit.

(((2)))

The medium accommodating device according to (((1))),
wherein the photographing unit photographs the side portions of the media in a width direction intersecting a sending direction of the media from an outside in the width direction, and
the irradiation unit irradiates the side portions of the media in the width direction with the light by adjusting the angle of the light by the adjusting unit.

(((3)))

The medium accommodating device according to (((1))) or (((2))),
wherein the adjusting unit includes a reflective portion that reflects the light emitted from the irradiation unit.

(((4)))

The medium accommodating device according to any one of (((1))) to (((3))),
wherein the adjusting unit adjusts an installation angle of the irradiation unit with respect to the loading unit.

(((5)))

The medium accommodating device according to (((4))),
wherein the adjusting unit rotates the irradiation unit around a rotating shaft to rotate the irradiation unit in the up-down direction.

(((6)))

The medium accommodating device according to (((3))),
wherein a plurality of reflective portions are provided, and
the adjusting unit adjusts the angle of the light irradiating the media by selection of the plurality of reflective portions.

(((7)))

The medium accommodating device according to (((6))),
wherein the adjusting unit adjusts an installation angle of the reflective portion on which the light from the irradiation unit is first reflected, with respect to the loading unit.

(((8)))

The medium accommodating device according to (((6))) or (7)),
wherein the adjusting unit rotates the reflective portion around a rotating shaft to rotate the reflective portion in the up-down direction.

(((9)))

The medium accommodating device according to any one of (((1))) to (((8))),
wherein the adjusting unit adjusts the angle of the light to include
   a first angle at which the side portions of the media are irradiated with the light from an upper side in the up-down direction of the media floated and separated by the air supply unit, and
   a second angle at which the side portions of the media are irradiated with the light from a lower side in the up-down direction of the media floated and separated by the air supply unit.

(((10)))

The medium accommodating device according to any one of (((1))) to (((9))),
wherein the irradiation unit emits light having directivity.

(((11)))

The medium accommodating device according to any one of (((1))) to (((10))), further comprising:
at least one processor,
wherein the processor is configured to:
   change an amount of air supplied by the air supply unit based on an image photographed by the photographing unit.

(((12)))

An image forming system comprising:
the medium accommodating device according to any one of (((1))) to (((11))); and
an image forming unit that forms an image on a medium sent from the medium accommodating device by the sending unit.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A medium accommodating device comprising:
a loading unit on which media are loadable in an up-down direction;
an air supply unit that supplies air to a plurality of the media loaded on the loading unit to float and separate the plurality of media;
a sending unit that sequentially sends the media that are floated and separated by the air supply unit;
a photographing unit that photographs a state in which the media are floated and separated by the air supply unit;
an irradiation unit that irradiates side portions of the media with light; and
an adjusting unit that adjusts an angle of the light irradiating the media from the irradiation unit.

2. The medium accommodating device according to claim 1,
wherein the photographing unit photographs the side portions of the media in a width direction intersecting a sending direction of the media from an outside in the width direction, and
the irradiation unit irradiates the side portions of the media in the width direction with the light by adjusting the angle of the light by the adjusting unit.

3. The medium accommodating device according to claim 1,
wherein the adjusting unit includes a reflective portion that reflects the light emitted from the irradiation unit.

4. The medium accommodating device according to claim 1,
wherein the adjusting unit adjusts an installation angle of the irradiation unit with respect to the loading unit.

5. The medium accommodating device according to claim 4,
wherein the adjusting unit rotates the irradiation unit around a rotating shaft to rotate the irradiation unit in the up-down direction.

6. The medium accommodating device according to claim 3,
wherein a plurality of reflective portions are provided, and
the adjusting unit adjusts the angle of the light irradiating the media by selection of the plurality of reflective portions.

7. The medium accommodating device according to claim 6,
wherein the adjusting unit adjusts an installation angle of the reflective portion on which the light from the irradiation unit is first reflected, with respect to the loading unit.

8. The medium accommodating device according to claim 7,
wherein the adjusting unit rotates the reflective portion around a rotating shaft to rotate the reflective portion in the up-down direction.

9. The medium accommodating device according to claim 1,
wherein the adjusting unit adjusts the angle of the light to include
a first angle at which the side portions of the media are irradiated with the light from an upper side in the up-down direction of the media floated and separated by the air supply unit, and
a second angle at which the side portions of the media are irradiated with the light from a lower side in the up-down direction of the media floated and separated by the air supply unit.

10. The medium accommodating device according to claim 1,
wherein the irradiation unit emits light having directivity.

11. The medium accommodating device according to claim 1, further comprising:
at least one processor,
wherein the processor is configured to:
change an amount of air supplied by the air supply unit based on an image photographed by the photographing unit.

12. An image forming system comprising:
the medium accommodating device according to claim 1; and
an image forming unit that forms an image on a medium sent from the medium accommodating device by the sending unit.

13. An image forming system comprising:
the medium accommodating device according to claim 2; and
an image forming unit that forms an image on a medium sent from the medium accommodating device by the sending unit.

14. An image forming system comprising:
the medium accommodating device according to claim 3; and
an image forming unit that forms an image on a medium sent from the medium accommodating device by the sending unit.

15. An image forming system comprising:
the medium accommodating device according to claim 4; and
an image forming unit that forms an image on a medium sent from the medium accommodating device by the sending unit.

16. An image forming system comprising:
the medium accommodating device according to claim 5; and
an image forming unit that forms an image on a medium sent from the medium accommodating device by the sending unit.

17. An image forming system comprising:
the medium accommodating device according to claim 6; and
an image forming unit that forms an image on a medium sent from the medium accommodating device by the sending unit.

18. An image forming system comprising:
the medium accommodating device according to claim 7; and
an image forming unit that forms an image on a medium sent from the medium accommodating device by the sending unit.

19. An image forming system comprising:
the medium accommodating device according to claim 8; and
an image forming unit that forms an image on a medium sent from the medium accommodating device by the sending unit.

20. An image forming system comprising:
the medium accommodating device according to claim 9; and
an image forming unit that forms an image on a medium sent from the medium accommodating device by the sending unit.
